(19) United States
(12) Patent Application Publication
(10) Pub. No.: US 2026/0195694 A1
(43) Pub. Date: Jul. 9, 2026

(54) VISUALIZATION OF CONSEQUENCES DUE TO WORKER SKILL GAPS ON INDUSTRIAL FLOORS

(71) Applicant: International Business Machines Corporation, Armonk, NY (US)

(72) Inventors: Binoy Thomas, Kozhikode (IN); Sarbajit Kumar Rakshit, Kolkata (IN); Sudheesh S. Kairali, Kozhikode (IN)

(21) Appl. No.: 19/010,268

(22) Filed: Jan. 6, 2025

(51) Int. Cl. G06Q 10/0639; G06N 20/00; G06Q 10/067; G06T 19/00

(52) U.S. Cl. CPC G06Q 10/06398; G06N 20/00; G06Q 10/067; G06T 19/006

(57) ABSTRACT

Examples described herein provide for visualizing consequences of skill gaps by a worker on an industrial floor. Aspects include receiving a digital twin model of an industrial floor, analyzing the digital twin model to identify an activity requiring human involvement and required skills for preforming the activity, and analyzing a performance of the activity of a worker on the industrial floor to determine a skill level possessed by the worker. Aspects also include identifying skill gaps of the worker based on the required skills and the skill level of the worker and executing digital twin simulations of manufacturing processes including the activity to model consequences resulting from the identified skill gaps. Aspects further include creating virtual reality (VR) visualizations that illustrate the consequences of the identified skill gaps and generating a skill gap reduction plan that mitigates adverse impacts associated with skill gaps.

### BACKGROUND

The disclosure relates to industrial automation and workforce training technologies, specifically to visualizing the consequences of skill gaps among workers on industrial floors using digital twin and virtual reality (VR) technologies.

Skill gaps among workers on industrial floors refer to the mismatch between the skills, knowledge, and competencies required to perform specific job tasks effectively and the skills possessed by the workers. This discrepancy can lead to several issues, including reduced productivity, quality issues, safety hazards, and increased downtime. Workers with skill gaps may struggle to perform tasks efficiently, leading to decreased productivity and output levels. Insufficient skills can result in errors, defects, and inconsistencies in manufacturing processes, leading to a decline in the quality of products or services. Additionally, workers lacking the necessary knowledge and training may inadvertently create safety hazards, leading to accidents and injuries in the workplace. Improper handling of machinery or equipment due to skill gaps can cause breakdowns and unplanned downtime, disrupting production schedules and increasing operational costs.

Addressing skill gaps through training, mentoring, and continuous learning programs is essential to enhance worker competencies and prevent these problems. A skilled and well-trained workforce can contribute to improved productivity, higher quality outputs, enhanced safety, and smoother operations on the industrial floor. Technologies on industrial floors are evolving, requiring workers to adapt to new ways of working.

### SUMMARY

According to one aspect of the present invention, a computer-implemented method for visualizing consequences of skill gaps among workers on an industrial floor is provided. The method includes receiving a digital twin model of an industrial floor, analyzing the digital twin model to identify an activity requiring human involvement and required skills for preforming the activity, and analyzing a performance of the activity of a worker on the industrial floor to determine a skill level possessed by the worker. The method also includes identifying skill gaps of the worker based on the required skills and the skill level of the worker and executing digital twin simulations of manufacturing processes including the activity to model consequences resulting from the identified skill gaps. The method further includes creating virtual reality (VR) visualizations that illustrate the consequences of the identified skill gaps and generating a skill gap reduction plan that mitigates adverse impacts associated with skill gaps.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment in accordance with an embodiment;

FIG. 2 illustrates a block diagram of a system for visualizing consequences of skill gaps on an industrial floor using digital twin and virtual reality technologies in accordance with an embodiment; and

FIG. 3 illustrates a flow chart diagram of a method for visualizing consequences of skill gaps among workers on an industrial floor in accordance with an embodiment.

The detailed description explains embodiments of the disclosure, together with advantages and features, by way of example with reference to the drawings.

### DETAILED DESCRIPTION

In industrial environments, the skill gap among workers presents a significant challenge. The skill gap refers to the discrepancy between the skills, knowledge, and competencies required to perform specific job tasks effectively and the skills possessed by the workers. This gap can lead to several issues, including reduced productivity, quality issues, safety hazards, and increased downtime. Workers with skill gaps may struggle to perform tasks efficiently, leading to decreased productivity and output levels. Insufficient skills can result in errors, defects, and inconsistencies in manufacturing processes, leading to a decline in the quality of products or services. Additionally, workers lacking the necessary knowledge and training may inadvertently create safety hazards, leading to accidents and injuries in the workplace. Improper handling of machinery or equipment due to skill gaps can cause breakdowns and unplanned downtime, disrupting production schedules and increasing operational costs.

Current solutions to address skill gaps often involve traditional training programs, mentoring, and continuous learning initiatives. While these methods can enhance worker competencies, they have several limitations. Traditional training programs may not effectively simulate real-world scenarios, leading to a lack of preparedness among workers when faced with actual tasks. Mentoring and continuous learning programs, although beneficial, may not provide immediate feedback on the consequences of skill gaps, making understanding the impact of their actions difficult for workers. Additionally, these methods may not be able to keep pace with the rapidly evolving technologies on industrial floors, requiring workers to adapt to new ways of working without adequate preparation.

The disclosed system addresses these challenges by utilizing digital twin and virtual reality (VR) technologies to visualize the consequences of skill gaps among workers on industrial floors. The system receives a digital twin model of the entire industrial floor and analyzes the activities where human involvement is necessary. The system identifies the specific skills required by the workers for interacting with machines, robots, AI systems, and other technologies. Based on the identified skill gaps, the system creates VR visualizations of the industrial floor to demonstrate various potential consequences that can occur due to the skill gap. These visualizations include scenarios such as accidents, poor quality of work products, and loss of productivity. By simulating different types of mistakes and delays in responding due to skill gaps, the system provides a comprehensive understanding of the impact of inadequate skills. This approach enables proactive training and skill enhancement programs, ensuring that workers are better prepared to perform their tasks effectively and safely. Visualizing the potential consequences of skill gaps can help in understanding the impact of inadequate skills and in planning appropriate training and skill enhancement programs. This visualization can be achieved through the use of simulation models, which can demonstrate various scenarios and potential outcomes of skill gaps in a controlled environment.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

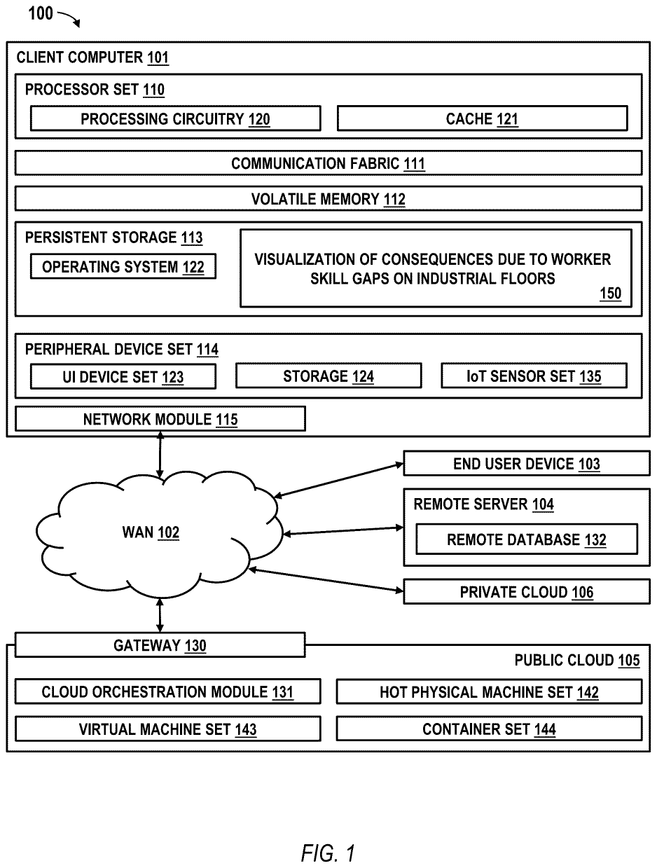

FIG. 1 illustrates a computing environment 100, according to an embodiment. Computing environment 100 contains an example of an environment for the execution of at least some of the computer code involved in performing the inventive methods, such as visualization of consequences due to worker skill gaps on industrial floors, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

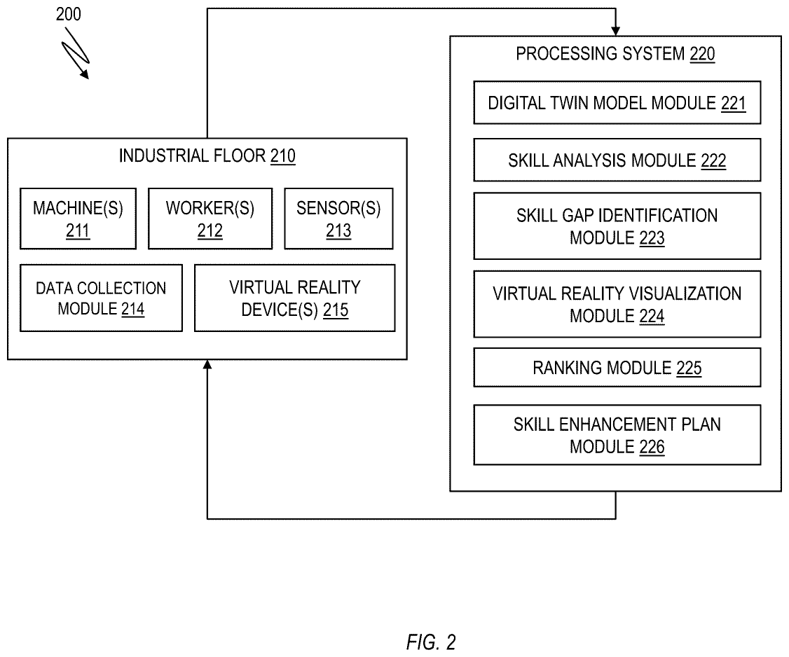

Referring now to FIG. 2, a block diagram of a system 200 for visualizing consequences of skill gaps on an industrial floor using digital twin and virtual reality technologies is shown. The system 200 includes an industrial floor 210, which serves as the primary environment where the various activities and interactions take place. The industrial floor 210 encompasses the machinery, workers, and processes involved in the manufacturing or production activities. The industrial floor 210 is equipped with multiple machine(s) 211, which include various types of equipment and devices used in the manufacturing processes. These machines can range from simple mechanical devices to complex automated systems, including robots and AI-driven machinery. The machine(s) 211 perform specific tasks and operations integral to the production workflow.

In exemplary embodiments, one or more worker(s) 212 are present on the industrial floor. The workers 212 are the human operators who interact with the machine(s) 211 on the industrial floor 210. The worker(s) 212 perform various activities, such as operating machines, monitoring processes, and making decisions that impact the overall production. The skills and competencies of the worker(s) 212 are essential to the efficient functioning of the industrial floor 210.

In exemplary embodiments, sensor(s) 213 are deployed throughout the industrial floor 210 to collect data on the performance and status of the machine(s) 211 and the activities of the worker(s) 212. These sensors can include IoT devices, cameras, and other monitoring equipment that capture real-time information on the industrial processes. In one example, IoT sensors can be used to monitor machine parameters such as temperature, pressure, vibration, and operational status, providing real-time data on the health and performance of the equipment. Cameras can be strategically placed to capture visual data on worker activities, machine operations, and overall workflow, enabling the system to analyze worker movements, detect deviations from standard procedures, and identify potential safety hazards. Additionally, wearable sensors can be used to monitor worker biometrics, such as heart rate, body temperature, and fatigue levels, providing insights into worker well-being and potential impacts on performance. Proximity sensors can detect the presence and movement of workers around machines, ensuring safe interactions and preventing accidents. Environmental sensors can measure factors such as air quality, noise levels, and lighting conditions, which can affect worker performance and safety. By integrating data from these diverse sensors, the processing system 220 can create a comprehensive and real-time view of the industrial floor, enabling accurate analysis and visualization of skill gaps and their consequences.

In exemplary embodiments, the data collection module 214 aggregates the data collected by the sensor(s) 213 and other sources. The data collection module 214 is responsible for gathering, processing, and organizing data to ensure that all relevant information is available for further analysis. The data collection module 214 receives data from various types of sensors deployed throughout the industrial floor, including IoT devices, cameras, wearable sensors, proximity sensors, and environmental sensors. Each type of sensor provides specific data points that contribute to a comprehensive understanding of the industrial processes and worker activities.

In exemplary embodiments, the data collection module 214 processes the raw data by filtering out noise and irrelevant information, ensuring that only accurate and useful data is retained. This processing step may involve data cleaning techniques, such as removing duplicate entries, correcting errors, and normalizing data formats. The data collection module 214 then organizes the processed data into structured formats, such as databases or data warehouses, making it easier to access and analyze. Additionally, the data collection module 214 integrates data from other sources, such as historical performance records, maintenance logs, and real-time data streams from the industrial floor. This integration allows the module to create a unified dataset that encompasses all aspects of the industrial environment, including machine performance, worker activities, and environmental conditions. The data collection module 214 also ensures data synchronization and consistency across different sources. The data collection module 214 continuously updates the dataset with new information, maintaining an up-to-date view of the industrial floor.

In exemplary embodiments, virtual reality (VR) device(s) 215 are used to create immersive VR environments that simulate the industrial floor 210. The VR devices 215 enable the visualization of various scenarios and potential consequences of skill gaps among the worker(s) 212. These visualizations provide a realistic and interactive platform for training and assessment, allowing workers to experience the potential outcomes of their actions in a controlled environment. One example of a visualization of consequences using a VR device 215 is the simulation of an accident scenario. If a worker fails to follow proper safety protocols due to a skill gap, the VR environment can demonstrate the potential consequences, such as a machine malfunction leading to an injury. The VR simulation can show the sequence of events that lead to the accident, highlighting the mistakes made by the worker. This immersive experience helps workers understand the importance of adhering to safety procedures and the potential risks associated with skill gaps.

Another example is the visualization of poor-quality work resulting from skill gaps. In the VR environment, workers can observe the impact of incorrect machine settings or improper handling of materials on the final product. The simulation can show defects, inconsistencies, and other quality issues that arise due to inadequate skills. By experiencing these consequences in a virtual setting, workers can better understand the importance of precision and accuracy in their tasks, leading to improved performance and product quality.

The VR device 215 can also be used to simulate scenarios involving loss of productivity. For instance, if a worker is unable to operate a machine efficiently due to a skill gap, the VR environment can demonstrate the resulting delays and disruptions in the production process. The simulation can show how the worker's mistakes lead to machine downtime, increased operational costs, and missed production targets. This visualization helps workers recognize the impact of their skills on overall productivity and motivates them to improve their competencies.

Additionally, the VR device 215 can be used to visualize the consequences of skill gaps in emergency situations. For example, if a worker lacks the necessary skills to respond to a fire or chemical spill, the VR environment can simulate the potential outcomes, such as the spread of the fire or contamination of the workspace. The simulation can show the steps that should have been taken to mitigate the emergency and the consequences of failing to do so. This immersive experience helps workers prepare for emergency situations and reinforces the importance of proper training and skills.

In exemplary embodiments, the processing system 220 is the central computational unit that manages the overall operations of the system 200. The processing system 220 includes several specialized modules that perform specific functions. In exemplary embodiments, the digital twin model module 221 creates and maintains a digital twin of the industrial floor 210. This digital twin is a virtual representation of the physical environment, including the machine(s) 211, worker(s) 212, and processes. The digital twin allows for detailed simulations and analyses of the industrial activities.

In exemplary embodiments, the skill analysis module 222 evaluates the skills and competencies of the worker(s) 212. This module analyzes the data collected by the data collection module 214 to determine the specific skills required for various tasks and the current skill levels of the worker(s) 212. The skill gap identification module 223 identifies the discrepancies between the required skills and the actual skills possessed by the worker(s) 212. This module highlights the areas where the worker(s) 212 need improvement to perform their tasks effectively.

In one embodiment, the skill analysis module 222 is configured to determine a required skill level for a worker performing a task by performing a comprehensive task analysis of the manufacturing processes on the industrial floor. The skill analysis module 222 also identifies all the steps and activities involved in each process, including decision-making points, quality control tasks, and intricate operations that machines cannot perform independently. The skill analysis module 222 then maps each step or activity to determine the specific skills and competencies required to perform the task effectively, including technical knowledge, manual dexterity, problem-solving abilities, and familiarity with machine interfaces and processes.

The skill analysis module 222 also analyzes historical data related to worker performance, including past task execution records, error rates, and feedback from supervisors. This data helps in understanding the skill levels of workers who have successfully performed similar tasks in the past. Additionally, the skill analysis module 222 assesses the complexity of each task by considering factors such as the number of steps, decision points, interdependencies, and cognitive load. Tasks with higher complexity levels require more advanced skills and competencies.

Based on the task analysis, skill mapping, historical data analysis, and complexity assessment, the skill analysis module 222 creates skill proficiency profiles for each worker. These profiles provide a detailed view of the worker's strengths and areas for improvement. The skill analysis module 222 then defines the specific skill requirements for each task, identifying the minimum skill levels needed to perform the task effectively and safely.

For example, for a task involving the operation of a CNC machine, the required skills may include technical knowledge of machine programming, manual dexterity to handle tools and materials, and problem-solving abilities to troubleshoot issues. The skill analysis module 222 analyzes historical data of workers who have successfully operated the CNC machine and identifies the skill levels needed for programming, tool handling, and troubleshooting. For a task involving quality control inspection, the required skills may include attention to detail, familiarity with quality standards, and the ability to use inspection tools and equipment. The skill analysis module 222 assesses the complexity of the inspection process, including the number of decision points and the cognitive load involved, to determine the skill levels needed for accurate and efficient quality control. For a task involving emergency response, such as handling a chemical spill, the required skills may include knowledge of safety protocols, quick decision-making abilities, and familiarity with emergency equipment. The skill analysis module 222 analyzes historical data of workers who have successfully responded to similar emergencies and identifies the skill levels needed for safety protocol adherence, decision-making, and equipment handling.

In exemplary embodiments, the virtual reality visualization module 224 generates VR visualizations based on the digital twin simulations. This module creates immersive scenarios that demonstrate the potential consequences of skill gaps among the worker(s) 212. The VR visualizations help in understanding the impact of inadequate skills on the industrial floor 210. The output of the VR visualization module 224 is transmitted to the VR device 215 to be displayed to a worker. This allows the worker to interact with the VR environment and experience the potential outcomes of their actions in a controlled and realistic setting. By visualizing the consequences of skill gaps, workers can gain a better understanding of the importance of their skills and the potential risks associated with inadequate training, leading to improved performance and safety on the industrial floor.

In exemplary embodiments, the ranking module 225 ranks the identified skill gaps based on their potential impact on the industrial processes. The ranking module 225 prioritizes the skill gaps that need immediate attention and informs the training initiatives accordingly. In exemplary embodiments, the ranking module 225 ranks the identified skill gaps based on their potential impact on the industrial processes. The ranking module 225 prioritizes the skill gaps that need immediate attention and informs the training initiatives accordingly. The ranking process can be performed using a scoring system that evaluates the severity and potential consequences of each skill gap. The scoring system can be determined by a manager of the industrial floor, who sets the relative importance on production levels, quality levels, and safety concerns.

For example, the manager may assign different weights to various factors based on their significance to the overall operation. Production levels might be given a weight of 40%, quality levels a weight of 30%, and safety concerns a weight of 30%. Each skill gap is then evaluated against these factors, and a composite score is calculated to determine its overall impact.

To illustrate, consider a skill gap related to the operation of a critical machine. The manager assesses the potential impact of this skill gap on production levels, quality levels, and safety concerns. If the skill gap is likely to cause significant production delays, the production score might be high. If it also leads to frequent quality defects, the quality score would be elevated. Additionally, if the skill gap poses a safety risk, such as improper handling of hazardous materials, the safety score would be substantial. The composite score for this skill gap is then calculated based on the weighted sum of these individual scores.

For instance, if the production impact score is 8 out of 10, the quality impact score is 7 out of 10, and the safety impact score is 9 out of 10, the composite score can be calculated as follows:

$$Composite Score = ( 0.4 \times 8 ) + ( 0.3 \times 7 ) + ( 0.3 \times 9 ) = 3.2 + 2.1 + 2.7 = 8.0$$

This composite score of 8.0 indicates a high-priority skill gap that requires immediate attention. The ranking module 225 uses these composite scores to create a prioritized list of skill gaps, ensuring that the most critical issues are addressed first.

Another example might involve a skill gap in quality control inspection. If the skill gap results in frequent defects and rework, the quality impact score would be high. If it also causes minor production delays, the production impact score might be moderate. If there are no significant safety concerns, the safety impact score would be low. The composite score for this skill gap is then calculated based on the weighted sum of these individual scores.

For instance, if the production impact score is 5 out of 10, the quality impact score is 9 out of 10, and the safety impact score is 2 out of 10, the composite score can be calculated as follows:

$$Composite Score = ( 0.4 \times 5 ) + ( 0.3 \times 9 ) + ( 0.3 \times 2 ) = 2.0 + 2.7 + 0.6 = 5.3$$

This composite score of 5.3 indicates a moderate-priority skill gap that should be addressed but may not require immediate action.

By using this scoring system, the ranking module 225 ensures that the skill gaps with the most significant impact on production levels, quality levels, and safety concerns are prioritized for training and skill enhancement initiatives. This approach enables the industrial floor to allocate resources effectively and address the most critical skill gaps to improve overall performance and safety.

The skill enhancement plan module 226 develops comprehensive plans to address the identified skill gaps. This module integrates the findings from the other modules and creates targeted training programs, automation strategies, and safety measures to mitigate the adverse impacts of skill gaps. The skill enhancement plan module 226 ensures that the worker(s) 212 are adequately prepared to perform their tasks efficiently and safely on the industrial floor 210.

Examples of targeted training programs include customized training sessions that focus on the specific skills required for particular tasks. For instance, if a worker lacks proficiency in operating a CNC machine, the training program may include hands-on practice sessions, instructional videos, and interactive simulations that teach the worker how to program, set up, and operate the machine correctly. Additionally, the training program may incorporate assessments and feedback to ensure that the worker has acquired the necessary skills.

Automation strategies can involve implementing physical changes to the operation of machines on the industrial floor to reduce the likelihood of errors caused by skill gaps. For example, if a worker frequently makes mistakes in setting machine parameters, the automation strategy may include installing automated parameter-setting systems that ensure the correct settings are applied consistently. This can be achieved through the use of sensors and control systems that automatically adjust machine settings based on predefined criteria, reducing the reliance on manual input and minimizing the risk of errors.

Another example of an automation strategy is the integration of collaborative robots (Cobots) that work alongside human workers to perform repetitive or complex tasks. Cobots can be programmed to handle tasks that require high precision, such as assembling components or performing quality inspections. By automating these tasks, the skill gap is mitigated, and the overall efficiency and accuracy of the production process are improved.

Safety measures can also involve physical changes to the operation of machines to enhance worker safety and reduce the risk of accidents. For instance, if a worker is at risk of injury due to improper handling of hazardous materials, the safety measures may include installing safety interlocks and barriers that prevent access to dangerous areas unless specific safety protocols are followed. Additionally, the use of real-time monitoring systems can detect unsafe conditions and automatically shut down machines to prevent accidents.

Another example of a safety measure is the implementation of ergonomic improvements to machines and workstations. If workers are experiencing fatigue or discomfort due to poor ergonomics, the safety measures may include redesigning workstations to provide better support, adjusting machine heights, and incorporating adjustable seating and anti-fatigue mats. These changes can help reduce the physical strain on workers and improve their overall well-being and productivity.

By developing targeted training programs, automation strategies, and safety measures that include physical changes to the operation of machines, the skill enhancement plan module 226 ensures that workers are better equipped to perform their tasks effectively and safely. This comprehensive approach helps mitigate the adverse impacts of skill gaps and enhances the overall performance and safety of the industrial floor.

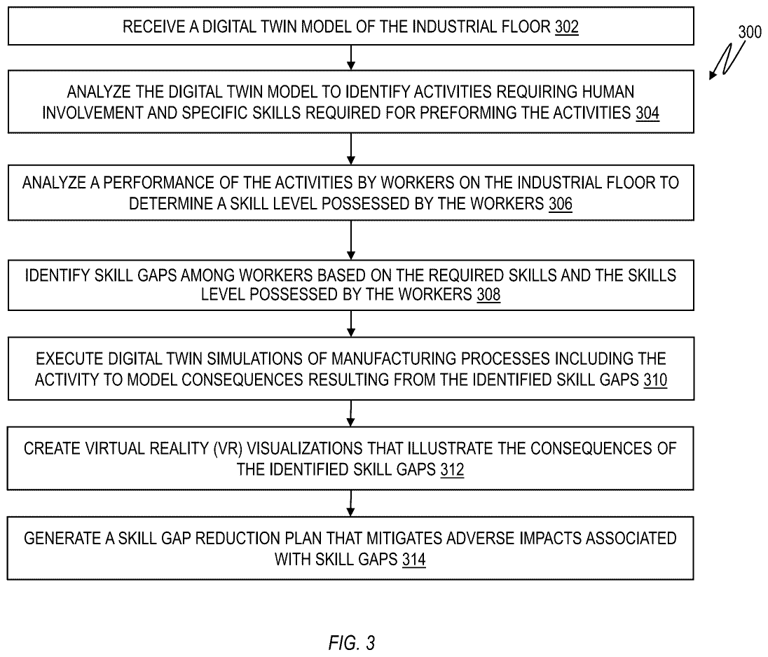

Referring now to FIG. 3, a flow chart illustrating a method 300 for visualizing consequences of skill gaps among workers on an industrial floor is shown. In exemplary embodiments, the method 300 can be implemented by the system 200 as described in FIG. 2. The method 300 begins with the step to receive a digital twin model of the industrial floor, as shown at block 302. Receiving a digital twin model of the industrial floor component involves obtaining a comprehensive virtual representation of the industrial floor, including all machines, processes, and worker activities. The digital twin model serves as the foundation for subsequent analyses and simulations, providing a detailed and accurate depiction of the physical environment.

The next step in the method 300 is to analyze the digital twin model to identify activities requiring human involvement and specific skills required for performing the activities, as shown at block 304. This component involves examining the digital twin model to pinpoint tasks and operations where human workers play a significant role. The analysis identifies the specific skills and competencies necessary for effective interaction with machines, robots, AI systems, and other technologies on the industrial floor. This step ensures that the system understands the skill requirements for each activity, enabling accurate identification of skill gaps.

Following the identification of required skills, the method proceeds to analyze the performance of the activities by workers on the industrial floor to determine a skill level possessed by the workers, as shown at block 306. This step involves evaluating the actual performance of workers during their tasks. The analysis considers various factors, such as task execution records, error rates, and feedback from supervisors, to assess the current skill levels of the workers. This step provides a clear understanding of the workers' competencies and highlights areas where they may need improvement.

Once the skill levels of the workers are determined, the method identifies skill gaps among workers based on the required skills and the skill levels possessed by the workers, as shown at block 308. This component involves comparing the identified skill requirements with the actual skill levels of the workers. The comparison reveals discrepancies or gaps in the workers' skills, indicating areas where they lack the necessary competencies to perform their tasks effectively. Identifying these skill gaps is essential for developing targeted training and skill enhancement programs.

The method 300 then executes digital twin simulations of manufacturing processes, including the activity to model consequences resulting from the identified skill gaps, as shown at block 310. This component involves running simulations within the digital twin model to replicate the manufacturing processes and activities on the industrial floor. The simulations introduce scenarios where workers' skill gaps lead to mistakes, delays, or other issues. By modeling these consequences, the system can predict the potential impact of skill gaps on productivity, safety, machine performance, and other factors.

Following the simulations, the method 300 creates virtual reality (VR) visualizations that illustrate the consequences of the identified skill gaps, as shown at block 312. This component involves generating immersive VR environments that depict the outcomes of the digital twin simulations. The VR visualizations provide a realistic and interactive platform for workers to experience the potential consequences of their skill gaps. These visualizations help workers understand the importance of their skills and the risks associated with inadequate training, leading to improved performance and safety on the industrial floor.

The final step in the method 300 is to generate a skill gap reduction plan that mitigates adverse impacts associated with skill gaps, as shown at block 314. This component involves developing comprehensive plans to address the identified skill gaps. The skill gap reduction plan includes targeted training programs, automation strategies, and safety measures designed to enhance workers' competencies and reduce the likelihood of mistakes. By implementing these plans, the system ensures that workers are better prepared to perform their tasks efficiently and safely, improving the overall performance and safety of the industrial floor.

In one embodiment, the system utilizes a comprehensive array of IoT sensors strategically placed throughout the industrial floor to monitor various parameters such as machine performance, environmental conditions, and worker activities. These sensors collect real-time data on temperature, pressure, vibration, and operational status of the machines, as well as visual data from cameras capturing worker movements and interactions with the equipment. The collected data is processed to identify skill gaps that could lead to accidents, such as improper handling of hazardous materials or failure to follow safety protocols. The VR visualizations then simulate potential accident scenarios, demonstrating the sequence of events that could result from these skill gaps, thereby emphasizing the importance of proper training and adherence to safety procedures.

In another embodiment, the system focuses on quality control processes by integrating advanced image recognition and machine learning algorithms to analyze the quality of work produced by the workers. The system identifies skill gaps that result in defects or inconsistencies in the final products. The VR visualizations in this embodiment showcase the impact of these skill gaps on product quality, highlighting defects and inconsistencies that arise from incorrect machine settings or improper handling of materials. This immersive experience helps workers understand the role of precision and accuracy in maintaining high-quality standards.

In a further embodiment, the system addresses productivity issues by monitoring the efficiency of workers in operating complex machinery. The system uses wearable sensors to track worker biometrics, such as heart rate and fatigue levels, which can affect their performance. The VR visualizations simulate scenarios where skill gaps lead to delays and disruptions in the production process, demonstrating how inefficiencies can result in machine downtime, increased operational costs, and missed production targets. This embodiment emphasizes the importance of skill enhancement in improving overall productivity and operational efficiency.

Additionally, in an embodiment focused on emergency response, the system simulates various emergency scenarios, such as fires or chemical spills, to assess the workers' preparedness and response capabilities. The VR visualizations demonstrate the potential consequences of skill gaps in handling emergencies, such as the spread of fire or contamination of the workspace. By experiencing these scenarios in a virtual environment, workers can better understand the necessary steps to mitigate emergencies and the importance of proper training in emergency response protocols.

In yet another embodiment, the system incorporates collaborative robots (Cobots) to assist workers in performing repetitive or complex tasks. The VR visualizations in this embodiment demonstrate how skill gaps in operating Cobots can lead to errors and inefficiencies. The simulations show the potential consequences of incorrect programming or improper interaction with Cobots, highlighting the need for workers to develop the necessary skills to work effectively alongside these automated systems. This embodiment underscores the role of automation in enhancing productivity and reducing the impact of skill gaps on the industrial floor.

In one embodiment, the system can alter the operation of a machine on the industrial floor by implementing automated parameter-setting systems. These systems can be designed to automatically adjust machine settings based on predefined criteria, thereby reducing the likelihood of errors caused by skill gaps. For instance, if a worker frequently makes mistakes in setting machine parameters, the system can use sensors and control algorithms to ensure that the correct settings are applied consistently, minimizing the risk of human error. In another embodiment, the system can integrate collaborative robots (Cobots) to assist workers in performing repetitive or complex tasks. Cobots can be programmed to handle tasks that require high precision, such as assembling components or performing quality inspections, thereby mitigating the impact of skill gaps. Additionally, the system can implement real-time monitoring and feedback mechanisms, where IoT sensors continuously track machine performance and worker interactions. If a deviation from the optimal operation is detected, the system can automatically adjust the machine's operation or provide immediate feedback to the worker to correct the mistake. Furthermore, the system can incorporate adaptive learning algorithms that analyze historical data and real-time performance metrics to predict potential skill gaps and dynamically adjust machine operations to compensate for these gaps. This approach ensures that the industrial floor operates efficiently and safely, even when workers have varying levels of skill and experience.

In one embodiment, the system utilizes historical data from the industrial floor to identify common skill gaps among workers by analyzing past performance records, error rates, and feedback from supervisors. This data-driven approach allows the system to pinpoint recurring issues and areas where workers frequently struggle. Machine learning algorithms are then employed to predict potential skill gaps based on worker performance data, such as task completion times, error frequencies, and the complexity of tasks performed. The system continuously updates the predictive models with new data to adapt to changing conditions and evolving skill requirements.

In another embodiment, the system integrates real-time data from IoT sensors on the industrial floor to update the digital twin model dynamically. These sensors monitor various parameters, including machine performance, environmental conditions, and worker activities, providing a comprehensive and up-to-date view of the industrial environment. The real-time data is processed to detect deviations from standard procedures, identify potential skill gaps, and predict the consequences of these gaps. The system can then generate alerts or recommendations for immediate corrective actions, such as additional training or adjustments to machine settings.

In a further embodiment, the system incorporates advanced image recognition and computer vision techniques to analyze visual data from cameras placed on the industrial floor. This visual data helps in identifying skill gaps related to manual tasks, such as assembly or quality inspection, by detecting errors in worker movements, improper handling of materials, or deviations from standard operating procedures. The system uses this information to refine the predictive models and provide targeted training recommendations. Additionally, the system can simulate various scenarios in a virtual reality (VR) environment, allowing workers to experience the potential consequences of skill gaps in a controlled and immersive setting. This VR-based training helps workers understand the importance of their skills and the impact of their actions, leading to improved performance and safety on the industrial floor.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for visualizing consequences of skill gaps by a worker on an industrial floor, the method comprising:
receiving a digital twin model of the industrial floor;
analyzing the digital twin model to identify an activity requiring human involvement and required skills for preforming the activity;
analyzing a performance of the activity of the worker on the industrial floor to determine a skill level possessed by the worker;
identifying skill gaps of the worker based on the required skills and the skill level of the worker;
executing digital twin simulations of manufacturing processes including the activity to model consequences resulting from the identified skill gaps;
creating virtual reality (VR) visualizations that illustrate the consequences of the identified skill gaps; and
generating a skill gap reduction plan that mitigates adverse impacts associated with skill gaps.

2. The computer-implemented method of claim 1, wherein the consequences of the identified skill gaps include accidents, poor quality work, and loss of productivity.

3. The computer-implemented method of claim 1, wherein generating the skill gap reduction plan includes altering an operation of a machine on the industrial floor to reduce a likelihood of one or more modeled mistakes.

4. The computer-implemented method of claim 1, wherein generating the skill gap reduction plan includes scheduling one or more of additional training for the worker and additional oversight of the worker by a supervisor.

5. The computer-implemented method of claim 1, further comprising providing the VR visualizations to the worker via an VR display device.

6. The computer-implemented method of claim 1, further comprising ranking the skill gaps based on the consequences resulting from the identified skill gaps and wherein the skill gap reduction plan is generated based at least in part on the rankings.

7. The computer-implemented method of claim 1, further comprising using historical data from the industrial floor to identify common skill gaps among workers and using machine learning algorithms to predict potential skill gaps based on worker performance data.

8. The computer-implemented method of claim 1, further comprising integrating real-time data from IoT sensors on the industrial floor to update the digital twin model.

9. A system comprising:
a memory comprising computer readable instructions; and
a processing device for executing the computer readable instructions, the computer readable instructions controlling the processing device to perform operations comprising:
receiving a digital twin model of an industrial floor;
analyzing the digital twin model to identify an activity requiring human involvement and required skills for preforming the activity;
analyzing a performance of the activity of a worker on the industrial floor to determine a skill level possessed by the worker;
identifying skill gaps of the worker based on the required skills and the skill level of the worker;
executing digital twin simulations of manufacturing processes including the activity to model consequences resulting from the identified skill gaps;
creating virtual reality (VR) visualizations that illustrate the consequences of the identified skill gaps; and
generating a skill gap reduction plan that mitigates adverse impacts associated with skill gaps.

10. The system of claim 9, wherein the consequences of the identified skill gaps include accidents, poor quality work, and loss of productivity.

11. The system of claim 9, wherein generating the skill gap reduction plan includes altering an operation of a machine on the industrial floor to reduce a likelihood of one or more modeled mistakes.

12. The system of claim 9, wherein generating the skill gap reduction plan includes scheduling one or more of additional training for the worker and additional oversight of the worker by a supervisor.

13. The system of claim 9, wherein the operations further comprise providing the VR visualizations to the worker via a VR display device.

14. The system of claim 9, wherein the operations further comprise ranking the skill gaps based on the consequences resulting from the identified skill gaps and wherein the skill gap reduction plan is generated based at least in part on the rankings.

15. The system of claim 9, wherein the operations further comprise using historical data from the industrial floor to identify common skill gaps among workers and using machine learning algorithms to predict potential skill gaps based on worker performance data.

16. The system of claim 9, wherein the operations further comprise integrating real-time data from IoT sensors on the industrial floor to update the digital twin model.

17. A computer program product for visualizing consequences of skill gaps by a worker on an industrial floor the computer program product comprising:
a set of one or more computer-readable storage media;
program instructions, collectively stored in the set of one or more storage media, for causing a processor set to perform the following computer operations:
receiving a digital twin model of an industrial floor;
analyzing the digital twin model to identify an activity requiring human involvement and required skills for preforming the activity;
analyzing a performance of the activity of a worker on the industrial floor to determine a skill level possessed by the worker;
identifying skill gaps of the worker based on the required skills and the skill level of the worker;
executing digital twin simulations of manufacturing processes including the activity to model consequences resulting from the identified skill gaps;
creating virtual reality (VR) visualizations that illustrate the consequences of the identified skill gaps; and
generating a skill gap reduction plan that mitigates adverse impacts associated with skill gaps.

18. The computer program product of claim 17, wherein the consequences of the identified skill gaps include accidents, poor quality work, and loss of productivity.

19. The computer program product of claim 17, wherein generating the skill gap reduction plan includes altering an operation of a machine on the industrial floor to reduce a likelihood of one or more modeled mistakes.

20. The computer program product of claim 17, wherein generating the skill gap reduction plan includes scheduling one or more of additional training for the worker and additional oversight of the worker by a supervisor.
